(19) United States
(12) Patent Application Publication
(10) Pub. No.: US 2022/0297269 A1
(43) Pub. Date: Sep. 22, 2022

(54) ADAPTOR FOR USE BETWEEN A STOP VALVE AND EXTENSION WRENCH

(71) Applicant: MERRILL MANUFACTURING COMPANY, Storm Lake, IA (US)

(72) Inventor: Stephen J. Anderson, Storm Lake, IA (US)

(21) Appl. No.: 17/206,167

(22) Filed: Mar. 19, 2021

(51) Int. Cl. B25B 13/50; B25B 13/48; F16K 31/50

(52) U.S. Cl. CPC B25B 13/50; B25B 13/481; F16K 31/50

(57) ABSTRACT

A stop valve adaptor to make a stop valve having a threaded stem actuatable through a stop valve box using a stop valve key. The stop valve adaptor is affixed to the threaded stop valve stem using a nut. The stop valve box is preferably made of a polymeric material and is maintained at a predetermined length by using friction due to O-rings, a glue joint, or clamping to dispose a stop valve box cover at the ground surface.

### TECHNICAL FIELD

This invention relates generally to a stop valve system including an adaptor fitted to a stop valve and providing the ability to actuate said stop valve with a stop valve key and a stop valve box for accessing the stop valve remotely.

### BACKGROUND

Stop valves, sometimes called curb stop valves, curb valves, corporation stop valves, or corporation valves, are valves placed strategically to allow or disallow the flow of fluid to specific destinations. Typical applications include a valve positioned between a water main and a home or business. Usually, this valve is located close to the water main, near the street curb, hence the name, curb stop valve. However, the same valve used for the same purpose may be located closer to the home or business, and may even be located inside said home or business. A stop valve attached directly to the water main is typically referred to as a corporation stop valve. Other uses include a farm or business having many use points for water, such as hydrants, stock waterers, irrigation sprinklers, heat exchangers, washing stations, etc. A stop valve may be installed to permit maintenance on parts of a water system while other parts continue in use, and to reduce damage if a water-system component fails.

Actuating a stop valve typically comprises turning a stem of said stop valve through an angle of 90°. The stop valve is located sufficiently deep in the ground to avoid freezing. The stop valve is made accessible by installing a valve box over the valve. A stop valve key of sufficient length is passed through the valve box to operatively engage the valve stem and turn it to open or close the stop valve.

Stop valves have, traditionally, been manufactured to include a stem or stem attachment shaped for the express purpose of engagement by the stop valve key. Many valves, possibly not expressly intended as stop valves however, are not made to for engagement by a stop valve wrench. Accordingly therefore, there is a need for an adaptor that may be installed on such a valve to provide a way to operatively engage the valve stem with a stop valve key.

### SUMMARY OF THE INVENTION

The present invention relates to an adaptor to allow valves not manufactured to be used as stop valves to be engaged by stop valve keys, and hence, to be used as stop valves. Further, this invention relates to a lighter, less expensive stop valve box made of a polymer.

Some valves have internal geometries that fully qualify them to be used as stop valves, yet they are not constructed to be engageable by a stop valve key. Many such valves have a valve stem machined or cast to be engage a handle, said handle not readily engageable by a stop valve key. An adaptor, made to engage the valve stem, provides purchase for a stop valve key so the valve may be actuated using the stop valve key.

### BRIEF DESCRIPTION OF THE DRAWINGS

The above needs are at least partially met through provision of the apparatus described in the following detailed description, particularly when studied in conjunction with the drawings, wherein:

FIG. 1 is a perspective view of the stop valve adaptor of the present invention, installed on a stop valve, and with a stop valve key socket;

FIG. 2 is a first elevation view of the stop valve adaptor of the present invention;

FIG. 3 is a second elevation view of the stop valve adaptor of the present invention;

FIG. 4 is a third elevation view of the stop valve adaptor of the present invention;

FIG. 5 is a fourth elevation view of the stop valve adaptor of the present invention;

FIG. 6 is a perspective view of the stop valve adaptor of the present invention;

FIG. 7 is a perspective view of an alternate embodiment of the stop valve adaptor of the present invention;

FIG. 8 is an elevation view of the alternate embodiment of the stop valve adaptor of the present invention;

FIG. 9 is a cutaway view of a key valve;

FIG. 10 is a cutaway view of an inverted key valve;

FIG. 11 is a cutaway view of a ball valve;

FIG. 12 is a plan view of a valve stem;

FIG. 13 illustrates shapes for valve stems and stop valve adaptor orifices;

FIG. 14 is a perspective view of a stop valve box;

FIG. 15 is a perspective view of the stop valve box and the stop valve;

FIG. 16 is a perspective view of the stop valve box separated into two parts;

FIG. 17 is a detail view of a smaller-diameter section of the stop valve box showing O-rings;

FIG. 18 is a perspective view of the stop valve box and stop valve key;

FIG. 19 is a perspective view of a first alternate embodiment of the stop valve key;

FIG. 20 is a perspective view of a second alternate embodiment of the stop valve key having a separate wrench; and

FIG. 21 illustrates shapes for stop valve key sockets and stop valve protrusions.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above, except where different specific meanings have otherwise been set forth herein.

Orientation of the figures are arbitrary. Orientation of the apparatus in practice is not limited to the orientation shown in the figures.

Filling, such as diagonal hatching, cross-hatching, dots, etc., indicates a cross-section or sliced view, or is used to differentiate features from neighboring features. In particular, such filling is not intended to convey material information. The present invention is not limited by material considerations.

### DETAILED DESCRIPTION

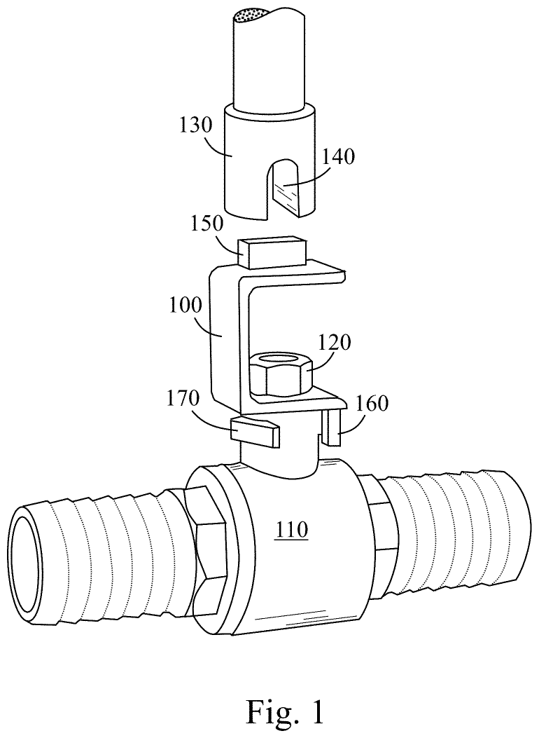

Referring now to the drawings, wherein like reference numerals indicate identical or similar parts throughout the several views, FIG. 1 shows a perspective view of the stop valve adaptor 100 of the present invention installed on a stop valve 110 and retained by a nut 120 threaded onto a stop valve stem 910, 1010, 1110 (see FIGS. 9-11). The stop valve stem threads 920 and nut threads (not shown) are compatible. A stop valve key socket 130 is shown above, to access the stop valve adaptor 100, and thereby to actuate the stop valve 110. The stop valve key preferably comprises an indentation 140 intended to engage a protrusion 150 on the stop valve adaptor 100. Once engagement is effected, a torque, or moment, may be applied to the stop valve adaptor 100 to turn the stop valve stem 910, 1010, 1110.

Typically, turning the stop valve stem 910, 1010, 1110 through an angle of 90° changes the stop valve's state from open to closed or from closed to open, depending on the direction turned and the initial state. To provide limits to the rotation of the stop valve stem 910, 1010, 1110, a finger 160 is preferably provided on the stop valve adaptor 100. The finger 160 engages stops 170 (only one shown in FIG. 1) operatively affixed to the stop valve 110 at the required limits of rotation. It should be noted, however, the present invention is not limited to a stop valve 100 requiring a 90° turn of the stop valve stem 910, 1010, 1110 to fully alter its mode.

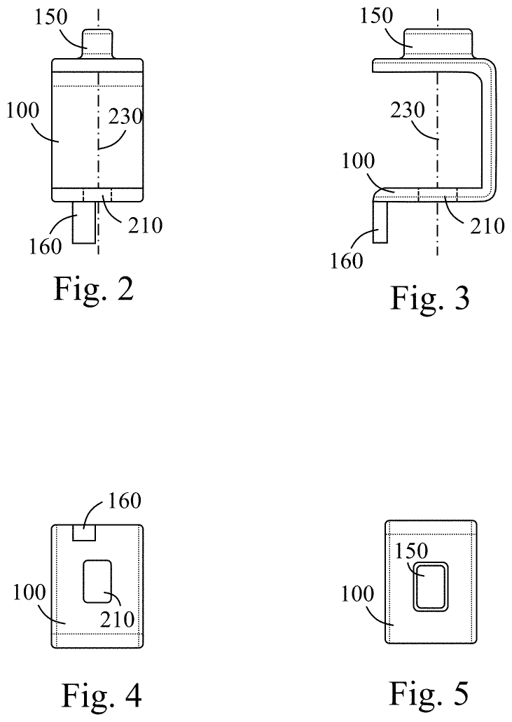

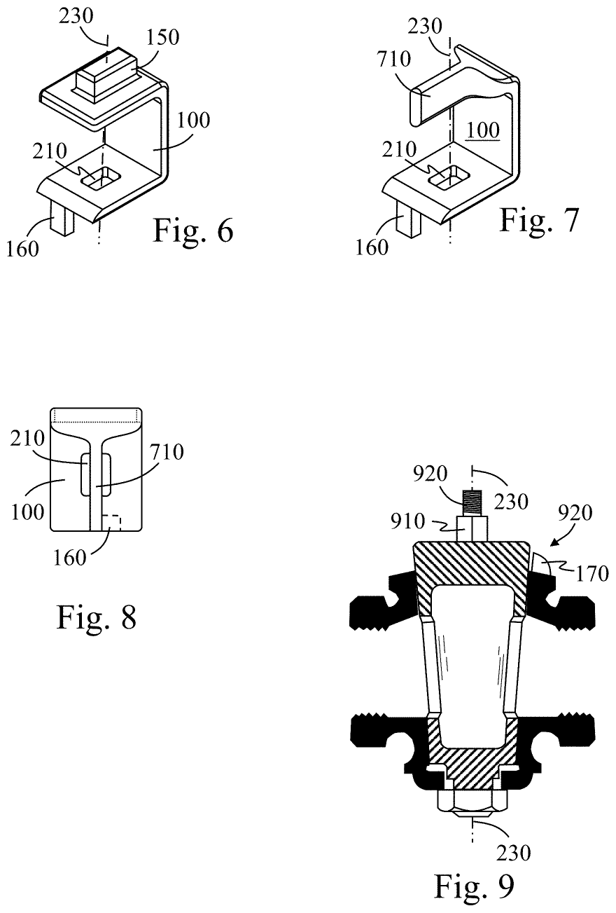

In FIGS. 2-6, the stop valve adaptor 100 is illustrated in various orientations. A typical installation would find the stop valve adaptor 100 oriented as shown in FIGS. 2-3, with the protrusion 150 uppermost. However, the present invention is not limited in this orientation.

An orifice 210 is provided through which the stop valve stem 910, 1010, 1110 passes and engages. Preferably, the orifice 210 is centered about an axis of rotation 230 of the stop valve stem 910, 1010, 1110, however, exact centering is not required for the functioning of the stop valve adaptor 100 of the present invention. As well, it is preferable that the protrusion 150 be centered on the axis of rotation 230 of the stop valve stem 910, 1010, 1110, but exact centering is not required for the functioning of the stop valve adaptor 100.

An alternate embodiment of the stop valve adaptor 100 of the present invention is illustrated in FIGS. 7-8. In this embodiment, the protrusion 710 is due to a modification of an upper portion of the stop valve adaptor 100. Regardless of the form the protrusion 150, 710 takes, it must be engageable by the stop valve key socket 130.

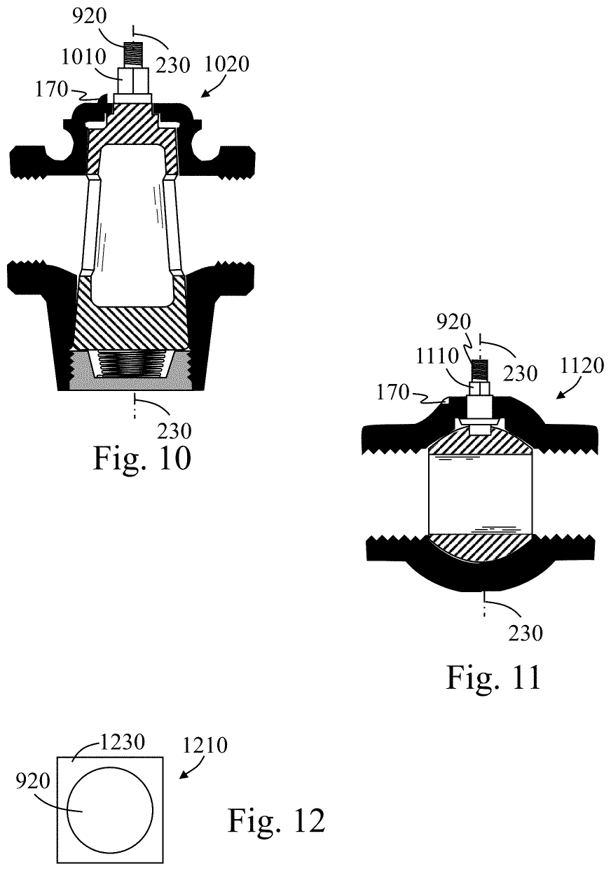

In FIGS. 9-11, three example valve geometries are illustrated. In FIG. 9, a plug or key valve 920 is shown. A similar valve, known as an inverted key valve 1020 is illustrated in FIG. 10. In FIG. 11, a ball valve 1120 is shown. The geometries of these valves are only given as valid examples for stop valves 110. Other geometries may be used, and the present invention is not limited to a particular valve geometry. Some other valve geometries are illustrated in the book, Flow of Fluids Through Valves, Fittings, and Pipe, (1988) Technical Paper No. 710, published by the Crane Company in King of Prussia, Pa. This book is hereby incorporated in its entirety by reference.

A plan view of the stop valve stem 910, 1010, 1110 is shown as 1210 in FIG. 12. A circular cross-section portion 920 is partially or fully threaded, as may be seen in FIGS. 9-11. A nut or other female-threaded fitting is screwed down over this circular cross-section portion 920 to secure the stop valve adaptor 100 to the stop valve stem 1210. A square cross-sectional portion 1230 is made to receive the indentation 210 of the stop valve adaptor 100 and provide surfaces such that a moment may be applied to the stop valve stem 1210 by the stop valve adaptor 100 when the stop valve adaptor 100 is turned by a user.

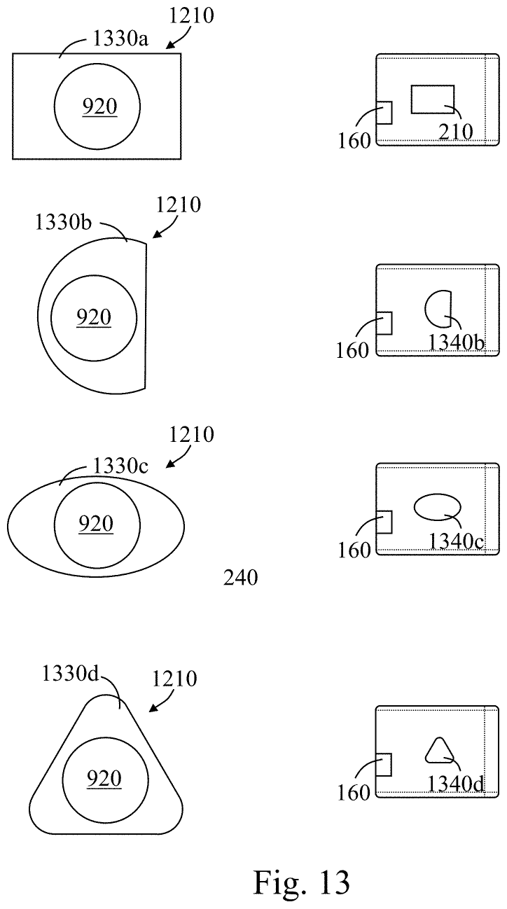

The valve stem 910, 1010, 1110, 1210 may be manufactured having almost any cross-sectional shape to engage the stop valve adaptor 100. A few acceptable shapes for this purpose are shown in FIG. 13. Just as a square cross-sectional portion 1230 may be used, so may a rectangular cross-sectional portion 1330a. Although a circular cross section is not ideal, a circular cross-section with at least one flat spot formed in the cross-sectional shape 1330b is acceptable. No flat spots are required, though, and an oval or elliptic cross-sectional shape 1330c may be employed. A cross-sectional shape based on a triangle with rounded vertices 1330d is also shown and may be used. An infinite number of other shapes may be employed, and the instant invention is not limited to a cross-sectional shape. Of course, the orifice 210, 1340b, 1340c, 1340d of the stop valve adaptor 100 preferably matches the valve stem cross-sectional shape 1230, 1330a, 1330b, 1330c, 1330d, regardless of the specific shape employed.

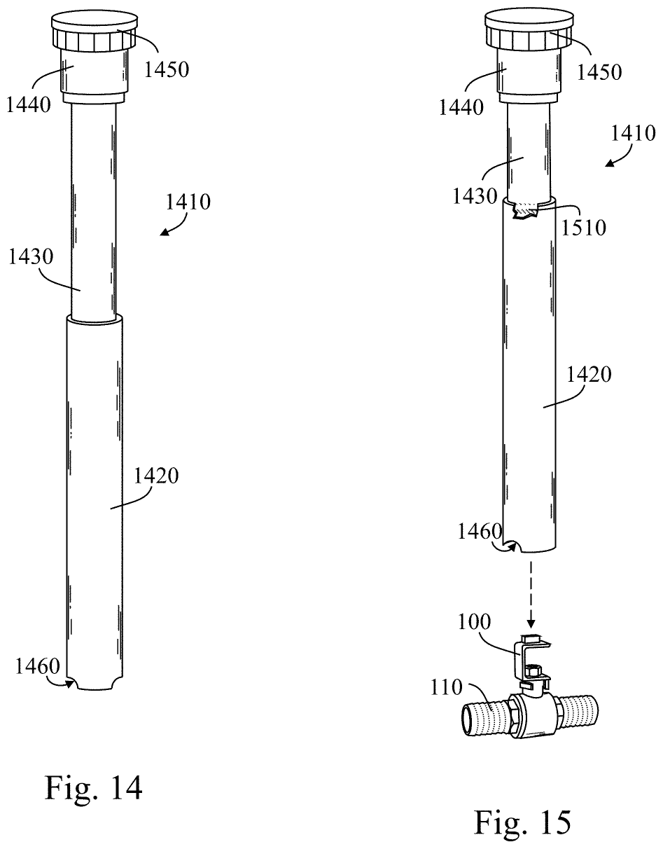

Some acceptable polymers for constructing a stop valve box 1410, shown in FIG. 14, include polyvinyl chloride (PVC), chlorinated polyvinyl chloride (CPVC), and Acrylonitrile Butadiene Styrene (ABS). The stop valve box 1410 is typically installed above the stop valve 110 to provide access to actuate the stop valve 110 when it is buried in the ground. However, the present invention is not limited to a vertically oriented stop valve box 1410 with the stop valve 110 at the bottom of the stop valve box 1410. If, for instance, a user requires the stop valve 110 to be behind a wall, such as in a basement or tunnel, the stop valve box 1410 may be oriented horizontally, or even at any angle from the horizontal. Again, a user may need to access a stop valve 110 above a ceiling—perhaps above a tunnel. In that case, the stop valve box 1410 may be oriented vertically, but the stop valve 110 would reside at the top of the stop valve box 1410.

The terms, upper and lower, herein, relate to the orientation of the stop valve box illustrated 1410 in FIGS. 14 and 15. Because the instant invention is not limited to any particular orientation, these terms may not apply, literally, to every installation.

A lower section 1420 of the stop valve box 1410 typically has a larger diameter cross-section and telescopically receives an upper section 1430, which typically has a smaller diameter cross-section. The lower section 1420 and upper section 1430 are typically joined to one another by gluing—sometime called welding, but this is a chemical process—or clamping with a collar that tightens the lower and upper sections 1420, 1430 together. An optional glue joint 1510 is shown in FIG. 15. A top flange 1440 is affixed to the upper section 1430 and is made to receive a removable cover 1450.

The telescopic nature of the stop valve box 1410 will be appreciated by comparing FIGS. 14 and 15. The stop valve box 1410 illustrated in FIG. 15 has been shortened compared to that of FIG. 14 by sliding the telescopic lower and upper sections 1420, 1430 toward one another. A desirable overall length is determined by disposing the cover 1450 at a ground level while the stop valve 110 is located at a safe depth in the ground. Additionally, FIG. 15 illustrates the relationship between the stop valve box 1410 and the stop valve 110. The stop valve adaptor 100 of the present invention is also shown affixed to the stop valve stem 910, 1010, 1110, 1210. The dashed arrow indicates that the stop valve box 1410 is lowered onto the stop valve 110 until the cutouts 1460 make contact with the stop valve 110 or the pipes (not shown) connected thereto. When the stop valve box 1410 is in place, the stop valve adaptor 100 is disposed inside the lower section 1420.

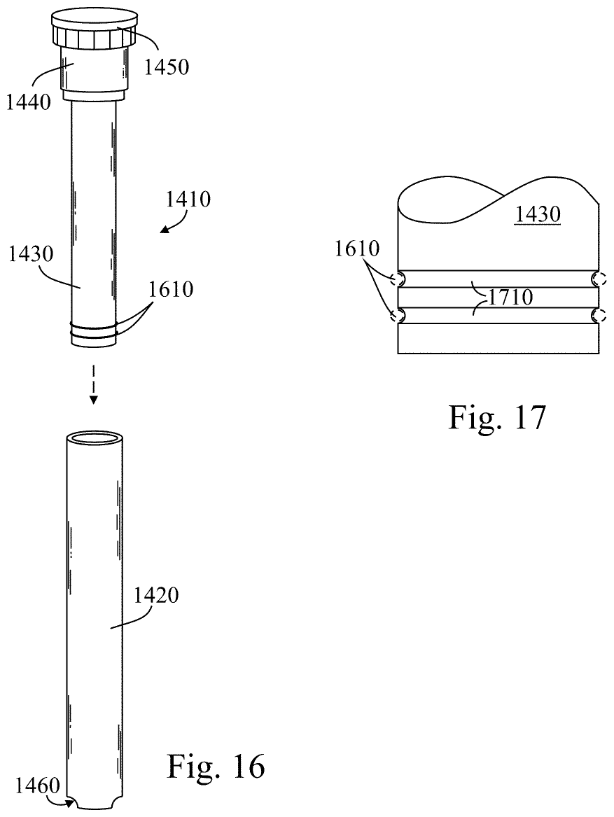

In FIG. 16, the upper, smaller diameter section 1430 is shown disengaged from the lower, larger diameter section 1420 of the stop valve box 1410. To put the stop valve box 1410 in condition to use, the upper section 1430 is inserted, telescopically, into the lower section 1420, as indicated by the dashed arrow. About the upper section 1430, near the lower end of that upper section 1430 where the upper section 1430 is inserted, telescopically, into the lower section 1420 for use in the field, at least one O-ring 1610 is installed. As shown in FIG. 17, in the upper section 1430, a groove 1710 for each O-ring 1610, shown in dashed lines in FIG. 17, used is formed or machined and into which the O-ring 1610 is operatively seated.

The O-ring, or O-rings, 1610 provides a friction fit between the upper section 1430 and the lower section 1420 and, hence, sufficient stability to the telescoping sections 1420, 1430 for backfilling the stop valve box 1410 in place. A glue joint 1510 is, therefore, optional, but may provide additional stability and seal. The O-ring, or O-rings, 1610 also provides a seal, disallowing dirt from entering the stop valve box 1410 from the outside, adjacent to a joint between the upper section 1430 and the lower section 1420.

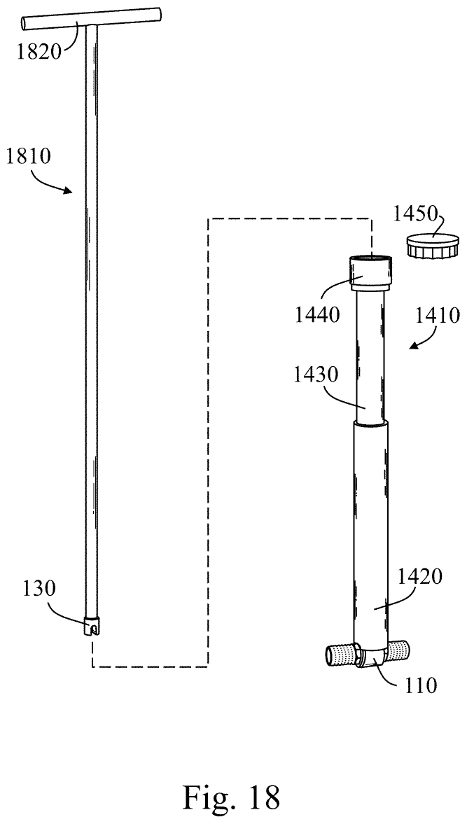

A stop valve key 1810 is used to access the stop valve 110 via the stop valve box 1410, as shown in FIG. 18. The stop valve key 1810 is inserted into the stop valve box 1410, as indicated by the dashed line. The stop valve key 1810 comprises a socket 130 to engage the protrusion 150, 710, and a handle 1820.

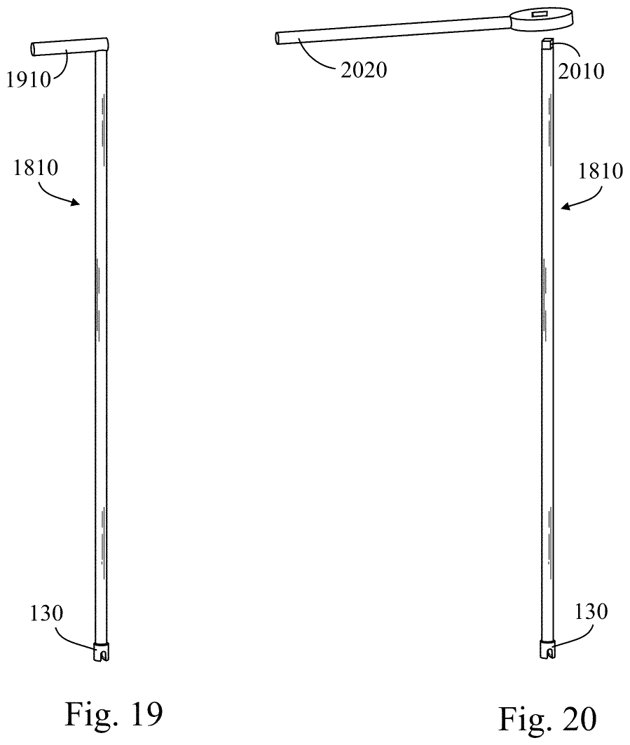

The T-shaped handle 1820 is preferable, but the present invention is not limited thereto. Another possible handle is an L-shaped handle 1910 shown in FIG. 19. In FIG. 20, an upper end 2010 of the stop valve key 1710 is shaped to engage a removable wrench 2020 made to fit the upper end 2010 of the stop valve key 1710.

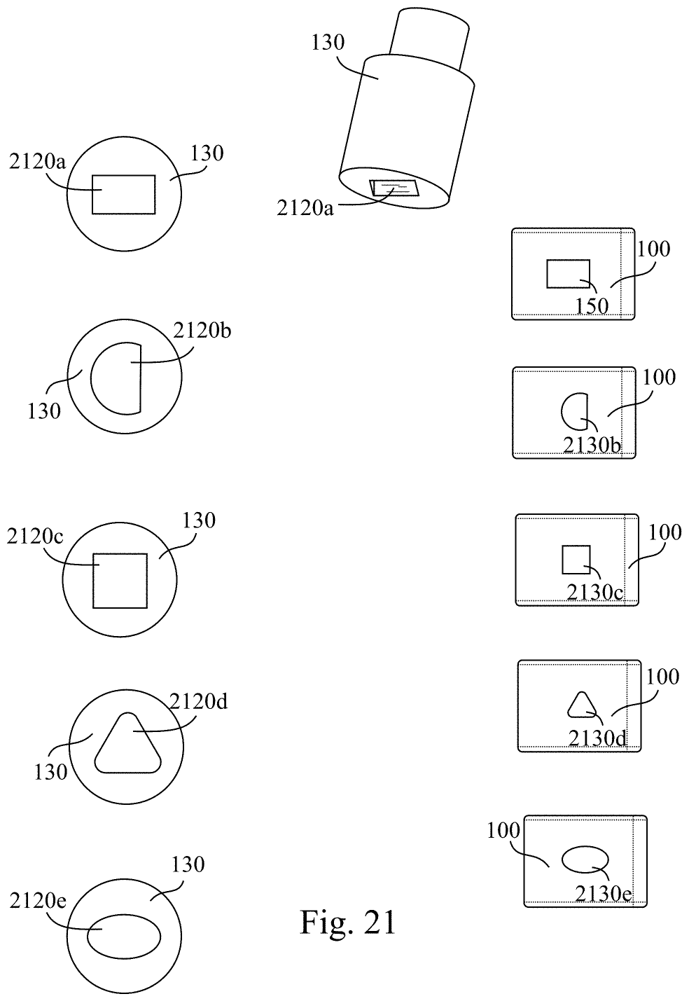

The protrusion 150, 710 may take many shapes, and hence, the socket 130 of the stop valve key 1610 may be made to fit the shape of the protrusion 150, 710. In FIG. 21, several views of the socket 130 are shown with a variety of possible indentation 2120a, 2120b, 2120c, 2120d, 2120e shapes. The shape of the protrusion 150, 710, 2130b, 2130c, 2130d, 2130e preferably matches the shape of the indentation 2120a, 2120b, 2120c, 2120d, 2120e as also shown in FIG. 20. The present invention is not limited to any particular shape of the protrusion 150, 710, 2130b, 2130c, 2130d, 2130e or of the indentation 2120a, 2120b, 2120c, 2120d, 2120e.

Those skilled in the art will recognize that a wide variety of modifications, alterations, and combinations can be made with respect to the above-described embodiments without departing from the spirit and scope of the invention, and that such modifications, alterations, and combinations are to be viewed as being within the ambit of the inventive concept as expressed by the attached claims.

I claim:

1. A stop valve adaptor system comprising:
(a) a stop valve;
(b) a stop valve adaptor;
(c) a stop valve stem comprising male threads and an axis of rotation;
(d) an orifice in the stop valve adaptor to engage the stop valve stem;
(e) a nut having female threads compatible with the male threads of the stop valve stem, said nut screwed onto the male threads of the stop valve stem to stabilize the stop valve adaptor;
(f) a protrusion on the stop valve adaptor located farther from the stop valve than the nut.

2. The stop valve adaptor system of claim 1 wherein:
the stop valve stem also comprises a portion having a given cross-sectional shape; and
the orifice in the stop valve adaptor has the given cross-sectional shape.

3. The stop valve adaptor system of claim 1 additionally comprising
a stop valve key comprising a socket having an indentation of a given cross-sectional shape;
wherein the protrusion on the stop valve adaptor comprises the given cross-sectional shape and is engaged by the stop valve key socket.

4. The stop valve adaptor system of claim 1 additionally comprising:
(a) a stop valve box; and
(b) a stop valve key having a socket for engaging the protrusion on the stop valve adaptor.

5. The stop valve adaptor system of claim 4 wherein the stop valve box comprises:
(a) a larger-diameter section;
(b) a smaller-diameter section operatively, telescopically engaging the larger-diameter section;
(c) a flange; and
(d) a cover.

6. A stop valve box comprising:
(a) a larger-diameter section made of a polymeric material;
(b) a smaller-diameter section made of the polymeric material operatively, telescopically engaging the larger-diameter section;
(c) a stabilizer to stabilize a position of the smaller-diameter section within the larger-diameter section;
(d) at least one cutout at an end of the larger-diameter section;
(e) a flange; and
(f) a cover.

7. The stop valve box of claim 6 wherein the stabilizer comprises at least one O-ring.

8. The stop valve box of claim 6 wherein the stabilizer comprises a glue joint.

9. The stop valve box of claim 6 wherein the polymeric material is selected from the group consisting of polyvinyl chloride (PVC), chlorinated polyvinyl chloride (CPVC), and Acrylonitrile Butadiene Styrene (ABS).

10. A stop valve system comprising:
(a) a stop valve having a stop valve stem;
(b) a stop valve adaptor having an orifice and a protrusion, said orifice to engage the stop valve stem, said protrusion being disposed farther from the stop valve than the orifice;
(c) a nut to operatively affix the stop valve adaptor to the stop valve stem;
(d) a stop valve box having a larger-diameter section disposed adjacent to the stop valve; and
(e) a stop valve key made to access the stop valve adaptor through the stop valve box.
